(19) United States
(12) Patent Application Publication
(10) Pub. No.: US 2025/0018604 A1
(43) Pub. Date: Jan. 16, 2025

(54) PROCESSING METHOD OF CUTTING THROUGH WORKPIECE AND PROCESSING SYSTEM

(71) Applicant: TCL ZHONGHUAN RENEWABLE ENERGY TECHNOLOGY CO., LTD., Tianjin (CN)

(72) Inventors: Haoming ZHANG, Tianjin (CN); Xuzhou YANG, Tianjin (CN); Rui WU, Tianjin (CN); Chen WEI, Tianjin (CN); Pengzhan ZHAO, Tianjin (CN)

(73) Assignee: TCL ZHONGHUAN RENEWABLE ENERGY TECHNOLOGY CO., LTD., Tianjin (CN)

(21) Appl. No.: 18/548,579

(22) PCT Filed: Jul. 31, 2023
(86) PCT No.: PCT/CN2023/110405

§ 371 Date: Sep. 1, 2023

(30) Foreign Application Priority Data
Aug. 31, 2022 (CN) 202211053022.5

(51) Int. Cl. B28D 5/00; B28D 5/04; G01B 11/06

(52) U.S. Cl. CPC B28D 5/0064; B28D 5/045; G01B 11/0608

(57) ABSTRACT

A processing method of cutting through a workpiece includes following steps: obtaining measured bow values of all areas in a wire net when a feed rate of a workpiece cutting reaches a preset threshold, comparing the measured bow values of all areas in an obtained wire net with a standard bow value when the workpiece is cut through, determining that the workpiece has been cut through when the measured bow values of all areas in the wire net are less than or equal to the standard bow value, and determining that the workpiece is not cut through when any area of the wire net has a measured bow value greater than the standard bow value.

### CROSS-REFERENCE TO RELATED APPLICATION

The present disclosure claims priority to and the benefit of Chinese Patent Application No. 202211053022.5 filed on Aug. 31, 2022, the disclosure of which is incorporated herein by reference in its entirety.

### TECHNICAL FIELD

The present disclosure relates to the field of wafer manufacturing technologies, and more particularly to a method and a system of processing whether ingot slices are cut through.

### BACKGROUND

When a rigid wire is not cutting an ingot, the rigid line between two sheaves is straight. The rigid wires between the sheaves form a very flat wire net. The entire net is tangent to the sheave, and a point of tangency between the entire net and the sheave is collinear. Wire bow is a very common phenomenon in the ingot slicing process. Once the wire bow exceeds its range, the wire bow may directly affect a cutting quality of the ingot. Especially at the end of ingot cutting, if the wire bow of the wire net is too large, positions on both sides of the ingot may be cut through but the middle position of the ingot may not be cut through. This further leads to the phenomenon that the ingot is not cut through, resulting in that the cut silicon wafers are all conjoined silicon wafers, which do not meet the processing requirements.

Existing slicing machines cannot automatically monitor whether the ingot is cut through and rely entirely on manual analysis and determinant. After each ingot cuts and shuts down, manually open a door of a slicing chamber, illuminate with a flashlight, and then remove a position of the wire net to observe the ingot cutting to determine whether the ingot has been cut through. If the ingot is not cut through, then close the door, manually increase the additional cutting program, and manually check the cutting situation while adding trimming, until the ingot is completely cut through. The existing manual identification and determinant method not only cannot guarantee the quality of ingot slicing, but also increases a downtime observation time. The work efficiency is extremely low, and the production cost is high, which seriously affects the production progress in the slicing production process.

### SUMMARY

The present disclosure provides a processing method and a processing system of cutting through a workpiece, which mainly solves the technical problems of how to automatically determine whether ingot slices are cut through in a production line, and how to complete cutting through the ingot if there is no through-cutting.

In order to solve at least one of the above-mentioned technical problems, the technical solution adopted in the present disclosure is as follows.

A processing method of cutting through a workpiece includes following steps:
obtaining measured bow values of all areas in a wire net when a feed rate of a workpiece cutting reaches a preset threshold;
comparing the measured bow values of all areas in an obtained wire net with a standard bow value when the workpiece is cut through;
determining that the workpiece has been cut through when the measured bow values of all areas in the wire net are less than or equal to the standard bow value; and
determining that the workpiece is not cut through when any area of the wire net has a measured bow value greater than the standard bow value.

In some embodiment of the present disclosure, the step of obtaining the measured bow values of all areas in the wire net includes:
controlling detection parts placed in a slicing chamber to continuously detect a position height of all areas in the wire net sequentially along a length direction of the workpiece, and obtaining a position value of a lowest point of all areas in the wire net; and
obtaining the bow values of all areas in the wire net based on a height difference between a position of the lowest point of each area in a detected wire net and a position of a tangent point between the wire net and a sheave.

In some embodiment of the present disclosure, the detection parts are placed on two sides of a width of the wire net, and an emission port of the wire net is disposed in a same direction as a rotation direction of the wire net; the detection parts placed on two sides of the width of the wire net alternately detect the wire net when the wire net rotates in a first rotation direction and rotates in a second rotation direction; and the first rotation direction is the rotation direction of the wire net when the wire net is fed in; the second rotation direction is the rotation direction of the wire net when the wire net is taken up.

In some embodiment of the present disclosure, when the workpiece is not cut through, performing an additional cutting program includes:
controlling the workpiece to raise a certain distance, and then additionally cutting the workpiece; when a total feed rate of an additional cutting reaches the preset threshold, obtaining the measured bow values of all areas in an additional cutting wire net;
comparing the measured bow values of all areas in an obtained additional cutting wire net with the standard bow value again to obtain a comparison result;
determining a cut-through of additionally cutting the workpiece based on the comparison result; and repeating the above steps until the workpiece is cut through.

In some embodiment of the present disclosure, when the workpiece is raised upwards, the wire net rotates slowly at a certain speed until the workpiece is raised to a set distance and stops rotating.

In some embodiment of the present disclosure, the wire net rotates in the first rotation direction at a speed less than or equal to 0.1 m/s during an upward raising of the workpiece.

In some embodiment of the present disclosure, the workpiece is raised upwards by 2 mm to 5 mm at a preset feed speed, and a distance of the workpiece raised upwards is a non-interrupted operation.

In some embodiment of the present disclosure, when additionally cutting the workpiece, the method further includes:
determining a length of an effective cutting line in a remaining wire amount in a spool; and
based on the length of the effective cutting line, determining the rotation direction of the wire net when additionally cutting the workpiece.

In some embodiment of the present disclosure, determining the length of the effective cutting line in the remaining wire amount in the spool includes:
determining whether there is a butt line in the remaining wire amount in the spool; and
based on a length of the butt line, determining the length of the effective cutting line.

In some embodiment of the present disclosure, based on the length of the butt line, determining the length of the effective cutting line includes:
when the length of the butt line is zero, the length of the effective cutting line is a length of the remaining wire amount;
when the length of the butt line is greater than zero, the length of the effective cutting line is the length of the remaining wire amount minus the length of the butt line.

In some embodiment of the present disclosure, based on the length of the butt line, determining the length of the effective cutting line includes:
determining whether the length of the effective cutting line is greater than a length of a preset minimum cutting line amount;
when the length of the effective cutting line is greater than the length of a minimum cutting line amount, then
the wire net is first rotated to a certain length in the second rotation direction to cut, and then rotated to a certain length in the first rotation direction to continue cutting;
rotating in the second rotation direction and then rotating in the first rotation direction to cut alternately until an ending of cutting;
wherein a length of the wire net rotating in the second rotation direction is greater than a length of the wire net rotating in the first rotation direction;
when the length of the effective cutting line is greater than the length of the minimum cutting line amount, then
the wire net is first rotated to a certain length in the first rotation direction to cut, and then rotated to a certain length in the second rotation direction to continue cutting;
rotating in the second rotation direction and then rotating in the first rotation direction to cut alternately until the ending of cutting;
wherein the length of the wire net rotating in the first rotation direction is greater than the length of the wire net rotating in the second rotation direction;
wherein the minimum cutting line amount is not less than 7000 m.

In some embodiment of the present disclosure, the length of the wire net rotating in the first rotation direction and the length of the wire net rotating in the second rotation direction remain unchanged.

In some embodiment of the present disclosure, when additionally cutting the workpiece, a wire net speed, the feed speed, and a coolant flow rate are same when the wire net rotates in the first rotation direction and in the second rotation direction.

A processing system of cutting through a workpiece includes:
a measurement module configured to obtain measured bow values of all areas in a wire net when a total feed rate of a workpiece cutting reaches a preset threshold;
a determiner configured to compare the measured how values of all areas in an obtained wire net with a standard bow value when the workpiece is cut through;
the determiner determines that the workpiece has been cut through when the measured bow values of all areas in the wire net are less than or equal to the standard bow value; and
the determiner determines that the workpiece is not cut through when any area of the wire net has a measured bow value greater than the standard bow value.

The processing method and the processing system designed by the present disclosure measure the bow state of the wire net through the detection part, and automatically calculate the wire value, and automatically determine whether the ingot is cut through. This can also automatically adjust the slicing and cutting plan, avoid downtime and waste of man-hours, and improve slicing yield and work efficiency.

### DESCRIPTION OF DRAWINGS

FIG. 1 is a flowchart of a processing method of cutting through a workpiece in the present disclosure.

FIG. 2 is a schematic view of a structure of a workpiece without cutting through in the present disclosure.

FIG. 3 is a signal connection diagram when a workpiece is cut in the present disclosure.

FIG. 4 is a graph of a bow value when a workpiece is not cut through in the present disclosure.

FIG. 5 is a graph of a bow value when a workpiece is not cut through in the present disclosure.

FIG. 6 is a distribution diagram of wire net areas in the present disclosure.

In the drawings:

10: Workpiece; 20: Wire net; 30: Sheave;
40; Detection part; 50: Controller.

### DETAILED DESCRIPTION OF EMBODIMENTS

The present disclosure will be described in detail below in conjunction with the accompanying drawings and specific embodiments.

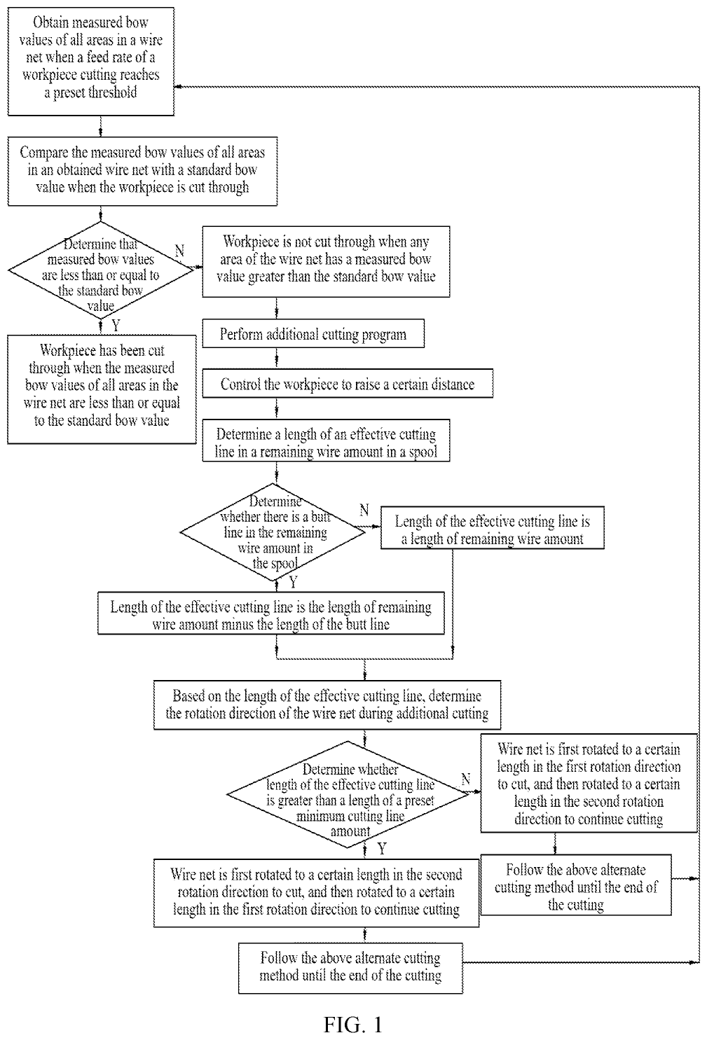

The present embodiment proposes processing method of cutting through a workpiece, as shown in FIG. 1, the steps include:

Obtaining measured bow values of all areas in a wire net 20 when a feed rate of a cutting of a workpiece 10 reaches a preset threshold.

Specifically, the workpiece 10 is fed downward step by step and cut by the wire net 20 during cutting. Along the height direction of the workpiece 10, the feed rate of the workpiece 10 is the value of its cut depth. When the cut depth of the workpiece 10 reaches a preset threshold, it is necessary to monitor the measurement bow values of all areas in the wire net 20. The preset threshold is less than the standard height of the workpiece 10, generally 2 mm to 5 mm less than the standard height of the workpiece 10. Set the cutting threshold so that there is a certain reference to make a cut-through determination.

Then, compare the measured bow values of all areas in the obtained wire net 20 with a standard bow value when the workpiece 10 is cut through. That is, it is determined whether the obtained measurement bow value of each area is less than or equal to the standard bow value.

Based on the state of the wire net 20 when the workpiece 10 is cut through, that is, the bow value of the wire net 20 when the workpiece 10 is cut through, the standard bow value of the wire net 20 is determined. The standard bow value of the wire net 20 may be determined based on the bow value of the wire net 20 after repeated successful cuts. The standard bow value is a range of values. The smaller the bow value is, the smaller the height change of the wire net 20 is when it is pressed and bent. It indicates that the cut depth of the workpiece 10 is closer to the standard value, and then it can be determined that the workpiece 10 has been completely cut through. And only when the measured bow values in all areas of the wire net 20 are less than or equal to the standard bow value, it indicates that the workpiece 10 is completely cut through by the wire net 20.

When the measured bow values of all areas in the wire net 20 are less than or equal to the standard bow value, it is determined that the workpiece 10 has been cut through.

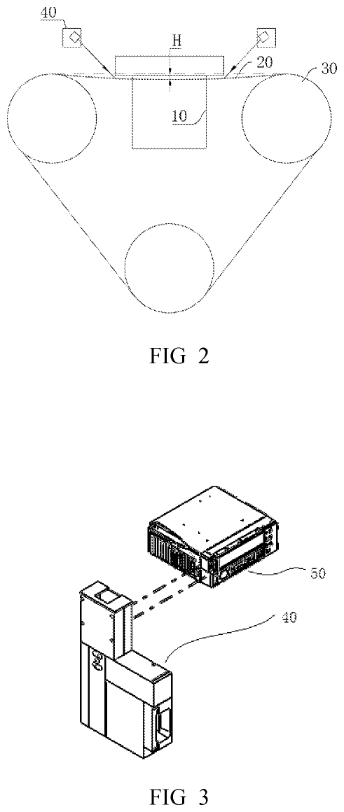

When the measured bow value of any area in the wire net is greater than the standard bow value, it is determined that the workpiece 10 is not cut through. For the uncut workpiece 10, the position of the lowest point in any area of the wire net 20 and the position of the tangent point between the wire net 20 and the sheave 30 form a height difference H in the vertical direction. This height difference H is called the bow value, as shown in FIG. 2. If the measured bow value in any area of the wire net 20 is greater than the standard bow value, the wire net 20 may be deformed by a large amount. It means that the workpiece 10 in this segment area is not cut through, which means that the workpiece 10 is not cut through.

The processing method of cutting through the workpiece provided by the present disclosure measures the bow state of the wire net through the detection part in real time, and automatically calculates the wire value, and automatically determines whether the ingot is cut through. This can also automatically adjust the slicing and cutting plan, avoid downtime and waste of man-hours, and improve slicing yield and work efficiency.

Further, in this embodiment, the steps of obtaining the measured bow values of all areas in the wire net 20 include:

Controlling detection parts 40 placed in a slicing chamber to continuously detect a position height of all areas in the wire net 20 sequentially along a length direction of the workpiece 10, and obtaining a position value of a lowest point of all areas in the wire net 20. The detection part 40 is provided in non-contact with the wire net 20. The detection part 40 continuously detects the position and height of the wire net 20 along the length direction of the workpiece 10, and may be one of a radar sensor, an optical fiber sensor, or an infrared sensor. This type of sensor continuously and uninterruptedly monitors the position of the diamond wire in each area. Especially in the slicing chamber where the light is dark during slicing, the position detection of the diamond wire can also be completed. And not affected by the amount of water mist, it can move back and forth along the length direction of the wire net 20 to detect the position and height of the diamond wire. This can detect the position and height of the diamond wire in each area, so as to obtain the dynamic and continuous bow value of the diamond wire.

As shown in FIG. 2, preferably, an emission port of the detection part 40 is set toward the side of the workpiece 10 in the width direction of the wire net 20. The detection part 40 is also provided with a protective housing specially used for the sensor, and the surface of the protective housing corresponding to the emission port of the sensor is a transparent surface, which facilitates the transmission of sensor signals. In addition, the transparent surface can also be cleaned when the detection part 40 is not in operation, so as to remove water mist and silica mud adhered to the transparent surface. Signal transmission as shown in FIG. 3, the sensor can detect the position information of the wire net 20 in each wire groove through electromagnetic energy pulse or photoelectric signal transmission during the slicing process. The transmitted signal is transmitted to the wire net 20 of the reflective object and then reflected back to the sensor by the wire net 20, so that the detection signal of the wire net 20 in each wire groove can be collected. Then the detection signal is transmitted to the external analysis and processing controller 50 for processing, so as to convert the collected detection signal into a digital signal. After analysis and optimization, a curve image that can be used to characterize the state of the wire net is obtained, so that the state of the wire net 20 can be visually monitored to determine whether the workpiece 10 is cut through. This provides real-time and full process coverage. Therefore, the risk of misjudgment or missed judgment in the prior art can be avoided by using a camera to take pictures or other sensors that must be identified under strong light to monitor the wire net 20. Further, it is not affected by the light intensity, not only has strong practical effect but also has high determination accuracy, and can monitor the working state of the wire net 20 in real time.

The bow values in all the areas in the wire net 20 are obtained based on the detected height difference between the position of the lowest point on the are surface in each area in the wire net 20 and the point of tangency between the wire net 20 and the sheave 30.

The emission port of the detection part 40 for detecting the position and height of the wire net 20 is set in the same direction as the wire net 20 rotates and is located on both sides of the wire net 20 in the width direction. When slicing, the wire net 20 cuts the workpiece 10 in reciprocating motion, and its motion mainly has two rotation directions. That is, the forward rotation of the wire net 20 when the wire is taken in and the reverse rotation when the wire is taken up. The first rotation direction is the forward rotation when the wire net 20 feeds in, and the second rotation direction is the reverse rotation when the wire net 20 is taken up. The rotation direction of the wire net 20 directly affects the direction of the cutting fluid splash. Therefore, when the wire net 20 rotates, the cutting fluid splashes along the rotation direction of the wire net 20. When the wire net 20 rotates in the first rotation direction, the cutting fluid may splash along the direction in which the wire net 20 rotates. When the wire net 20 is in reverse rotation when the wire net 20 is taken up, the cutting fluid splashes along with the direction in which the wire net 20 rotates. Therefore, the emission port of the radar detector needs to be arranged along the rotation direction of the wire net 20. That is, the emission port of the radar detector in the detection part 40 and the rotation direction of the wire net 20 are in the same direction. Therefore, the splash of cutting fluid and silicon mud caused by the rotation of the wire net 20 can be reduced, and the accuracy of its detection and identification can be ensured.

Preferably, as shown in FIG. 3, in order to ensure that the working state of the wire net 20 in the first direction of forward rotation and the working state in the second direction of reverse rotation can be clearly and accurately monitored and detected, the detection parts 40 are arranged on both sides of the width of the wire net 20 and monitor the state of the wire net 20 in the length direction, and the detection parts 40 on both sides of the width of the wire mesh 20 are oppositely arranged.

Specifically, the detection part 40 detects the position of the first and second rotation directions of the wire net 20 when it rotates. As for the wire net 20 of the first rotation direction, it rotates in the same direction relative to the detection part 40 on the left side and rotates in the opposite direction relative to the detection part 40 on the right side. For the wire net 20 of the second rotation direction, it rotates in the same direction relative to the detection part 40 on the right side and rotates in the opposite direction relative to the detection part 40 on the left side. During operation, the detection parts 40 placed on both sides of the width of the wire net 20 respectively monitor the wire net 20 in the first rotation direction and the wire net 20 in the second rotation direction. Furthermore, the detection parts 40 placed on both sides of the width of the wire net 20 perform alternate detection when the wire net 20 rotates in the first rotation direction and rotates in the second rotation direction.

That is to say, when the wire net 20 slices in the direction of the first rotation direction, the rotation direction is forward rotation relative to the left detection part 40 and reverse rotation relative to the right detection part 40. The detection part 40 on the left side starts to work and the detection part 40 on the right side does not work. The detection part 40 on the left side moves along the length direction of the wire net 20 to continuously monitor the working state of the wire net 20 in the first rotation direction until the end of the first rotation direction.

When the first rotation direction is switched to the second rotation direction, the rotation direction is reverse rotation relative to the left detection part 40 and forward rotation relative to the right detection part 40. Then the detection part 40 on the left side starts to return to its initial position, and the detection part 40 on the right side starts to work. Similarly, the detection part 40 on the right side monitors the working state of the wire net 20 in the second rotation direction with a preset activity track until the second rotation direction ends.

The above steps are repeated until the slicing is completed, thereby completing the state monitoring of the whole cutting process of the wire net 20. This enables the wire net 20 to be clearly and accurately monitored and detected no matter which direction of rotation the wire net 20 is in.

When the workpiece 10 is not cut through, the controller 50 directly controls the slicer to execute an additional cutting program.

Specifically, the workpiece 10 is firstly controlled to be lifted up by a certain distance, and then the workpiece 10 is subjected to additional cutting.

When the feed rate of the additional cutting reaches a predetermined threshold, the above method is used again to obtain the measurement bow values of all areas in the additional cutting wire net 20;

And compare the measured bow value and the standard bow value of all areas in the obtained additional cutting wire net again, and obtain the comparison result;

Based on the comparison result, determine the cut-through situation of the workpiece 10, that is, determine whether the workpiece 10 is cut through;

If it is cut through, the additional cutting ends;

If not cut through, repeat the above steps until the workpiece 10 is cut through.

The setting of the additional cutting program can compensate the position of the uncut workpiece 10, so that the corresponding slices can fully meet the standard requirements after being cut.

That is, before performing the additional cutting each time, the workpiece 10 must be raised upwards by a certain distance, and then the additional cutting operation is performed. And when the feed amount of the additional cutting reaches the predetermined threshold, that is, when the feed amount of the additional cutting reaches the predetermined threshold, the bow value of each area in the wire net 20 starts to be detected. And compare the measured bow value of the wire net 20 in each area with the standard bow value, and then determine whether the additional cutting completely cuts through the workpiece 10. If the workpiece 10 is completely cut through, then end. If the workpiece 10 is not cut through, continue to repeat the above steps to operate.

Specifically, when the workpiece 10 is raised upwards, the wire net 20 rotates slowly at a certain speed until the workpiece 10 is raised to a set distance and stops rotating. The purpose is to prevent the workpiece 10 from increasing the friction between the surface of the static wire net 20 and the slice during the process of lifting the workpiece 10 upwards, thereby causing the quality of the slice surface to fail to meet the requirements. Therefore, it is required that the wire net 20 rotates along the first rotation direction at a speed less than or equal to 0.1 m/s when the workpiece 10 is raised upwards. When the workpiece 10 is cut, no matter how much remaining wire remains on the spool, the wire net 20 may slowly rotate in the way that the new wire feeds the wire when the workpiece 10 is raised upwards. Even if the wire net 20 rotates slowly in the forward wire feed manner of the first rotation direction. Preferably, the speed of the wire net 20 is less than or equal to 0.1 m/s if the wire net 20 rotates slowly and does not remain stationary. The reference value can be 0.01 m/s, 0.015 m/s, 0.02 m/s, 0.025 m/s, 0.03 m/s. 0.35 m/s, 0.04 m/s, 0.45 m/s, 0.05 m/s, 0.55 m/s, 0.06 m/s, 0.65 m/s, 0.07 m/s, 0.75 m/s, 0.08 m/s, 0.95 m/s, 0.09 m/s, 0.95 m/s, or 0.1 m/s.

The workpiece 10 is raised upwards at a preset feed rate of 2 mm to 5 mm, and the workpiece 10 is raised upwards in a non-interrupted operation. That is, one-time upward increase of 2 mm to 5 mm, the reference value is 2 mm. 3 mm, 4 mm or 5 mm. The purpose of raising upwards is to prevent the wire bow of the wire net 20 from cutting a resin plate above the workpiece 10 first when the wire bow of the wire net 20 is greater than the standard bow value during cutting, because the width of the resin plate is greater than the width of the workpiece 10. When the workpiece 10 is not cut through, the workpiece 10 is directly cut, which may cause the resin plate to contact the cutting line first and be stretched by the resin plate to form a larger wire bow. This results in an actual bow value that is greater than the standard bow value so that the workpiece 10 is again not fully cut through.

Preferably, the preset speed range when the workpiece 10 is raised upwards is 5-10 mm/min. That is, when the workpiece 10 is lifted upward, the workpiece 10 moves upward at a constant speed, and the speed range of its upward movement is 5-10 mm/min. This can not only include the endpoint values of 5 mm/min and 10 mm/min at both ends, and it can also be 6 mm/min, 7 mm/min, 8 mm/min, 9 mm/min and other values.

Further, when performing additional cutting, the method further includes:
determining a length of an effective cutting line in a remaining wire amount in a spool.

Specifically, since the workpiece 10 is in the cutting process, the new diamond wire may first be sent forward to use in the first rotation direction, and then reversed and used in the second rotation direction. The new diamond wire that has been used once is the old wire, that is, the diamond wire used when returning the wire is the old wire. All new diamond wires have been following the first forward rotation direction to feed the wire for a certain length of cutting, and then rotate the second reverse rotation direction for a certain length to continue cutting. According to this switching rotation, the workpiece 10 is cut in this way. In addition, the length cut with the first rotation direction is greater than the length cut with the second rotation direction, that is, the length of the new wire for feeding is greater than the length of the old wire for taking up. Only in this way can the diamond wire be consumed continuously, ensure the maximum utilization of the diamond wire cutting, and ensure the cutting quality. The diamond wires that have been used are taken back, and the amount of new wire is greater than that of old wire. This not only makes effective use of the cutting performance of the diamond wire, but also sufficiently and advantageously slices and cuts the workpiece 10. Therefore, when the cutting of the workpiece 10 is completed, there is less the remaining wire amount in the old thread spool for thread removal. It is necessary to further determine the length of the effective cutting line that can be used for cutting in the remaining wire amount. Because the diamond wire must be a long wire that can sustainably form the entire cutting cycle when slicing, there must be no joints, that is, no joints. Knots can create large scratches on the surface of the slice, seriously affecting cut quality. Therefore, when slicing, avoid diamond wires connected by knots, and must be excluded from the effective length of the cutting line.

Based on the length of the effective cutting line, determine the rotation direction of the wire net when performing additional cutting.

Determining the length of the effective cutting line in the remaining wire amount in the spool mainly include the followings:

This spool is the spool for the old wire amount. With the deepening of cutting, the old wire used for off-line is gradually withdrawn, and the remaining old wire that can be used for off-line is very small. When perform additional cutting, first determine whether there is a butt line in the remaining wire amount in the spool wound by the old wire used for the offline wire. These knots are the knots caused by the reconnection of broken wires or the knots formed by cutting all the old wires and reconnecting them.

Then, based on a length of the butt line, determine the length of the effective cutting line.

When the length of the butt line is zero, that is, there is no butt line, and there is no knot, the length of the effective cutting line is the total length of the remaining wire amount.

When the length of the butt line is greater than zero, that is, a butt line appears, and the length of the butt line needs to be subtracted, then the length of the effective cutting line is the total length of the remaining line amount minus the length of the butt line.

Based on the length of the effective cutting line, determining the rotation direction of the wire net 20 during additional cutting includes the followings:

Comparing the length of the effective cutting line with the length of a minimum cutting line amount, that is, determine whether the length of the effective cutting line is greater than the length of the minimum cutting line amount.

When the length of the effective cutting line is greater than the length of the minimum cutting line amount, that is, the length of the existing old wire that can be used for off-line can complete at least one complete cutting cycle. Then, the wire net 20 first rotates for a certain length according to the second rotation direction for cutting, and then rotates for a certain length according to the first rotation direction to continue cutting. That is to say, put the old wire for a certain length first, and then receive the new wire for a certain length. Alternate cutting in this way repeatedly until the end of the cutting. During this process, the length of the wire net 20 rotating in the second hand direction is greater than the length rotating in the first hand direction each, time the alternate direction is cut. The purpose is to maintain the consistency of cutting of the wire net 20. For example, the wire net 20 first rotates according to the second rotation direction, that is, the old wire is laid out for 1500 m first. Then rotate according to the first rotation direction, that is, a new wire of 1100 m is collected. Alternate cutting operations like this until the end of cutting.

When the length of the effective cutting line is less than the length of the minimum cutting line amount, that is, the length of the existing old wire that can be used for offline cannot complete a complete cutting cycle. Then, the wire net 20 is first rotated for a certain length according to the first rotation direction for cutting, and then rotated for a certain length according to the second rotation direction to continue cutting. That is to say, put the new wire for a certain length first, and then collect the old wire for a certain length. Alternate cutting in this way repeatedly until the end of the cutting. During this process, the length of the wire net 20 rotating in the first hand direction is greater than the length rotating in the second hand direction each time the alternate direction is cut. For example, the wire net 20 first rotates according to the first rotation direction, that is, the new wire is laid out for 1500 m first. Then rotate according to the second rotation direction, that is to say, collect the old wire for another 1100 m. Alternate cutting operations like this until the end of cutting.

In the two cutting modes of the upper speed, the length of the wire net 20 rotating in the first rotation direction and the length of rotating in the second rotation direction remain unchanged. The minimum cutting line amount is not less than 7000 m, preferably, the minimum cutting line amount is 7000 m.

Further, during additional cutting, a wire net speed, the feed speed, and a coolant flow rate are same when the wire net rotates in the first rotation direction and in the second rotation direction. That is to say, no matter whether it is an alternate method of first rotating for a certain length according to the second rotation direction and then cutting according to the first rotation direction for a certain length, or an alternate way of cutting according to the first rotation direction for a certain length and then rotating for a certain length according to the second rotation direction, the feed speed of the workpiece 10, that is, the speed of the downward movement, the speed of the rotation of the wire net 20, and the flow rate of the cutting fluid are the same. The purpose is to ensure the consistency of cutting the wire net 20. Preferably, the wire speed of rotation of the wire net 20 is not less than 30 m/s, including the endpoint value of 30 m/s. The feed rate of the workpiece 10 is not less than 0.2 mm/min inclusive of the endpoint value 0.2 mm/min. The flow rate of cooling liquid is not less than 240 L/min, including the endpoint value of 240 L/min.

In order to enable those skilled in the art to further understand the method of the present disclosure, the technical solution of the present disclosure will be explained in detail below in conjunction with specific embodiments. Apparently, the described embodiments are only some of the embodiments of the present disclosure, but not all of them.

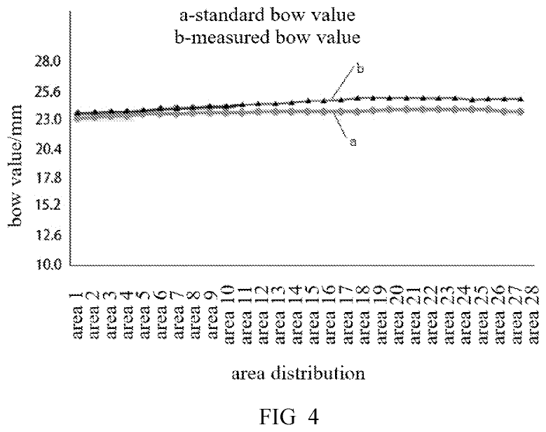

A workpiece 10 with a size of 210 mm is cut according to the method of the present disclosure. At the end of cutting, the detection part 40 measures the graph of the bow value in each area, as shown in FIG. 4. The abscissa is the area uniformly distributed along the length direction of the workpiece 10, and the area distribution is shown in FIG. 6. The ordinate represents the bow value, and it can be seen from the figure that the detection part 40 detects the position of the wire net 20. The detected signal is transmitted to the controller 50 and then converted into data, and the curve of the bow value at each position of the entire wire net is displayed in the same coordinate system. The standard bow value when the workpiece 10 cuts through is shown in line a. The measurement bow value measured by the detection part 40 is shown as line b. It can be seen from the figure that the measured bow values obtained from the area 6 to the area 28 are all greater than the standard bow value, which means that the workpiece 10 has not been cut through from the area 6 to the area 28. Correspondingly, in FIG. 6, the lines from the area 6 to the corresponding areas in the area 28 will turn red for warning, indicating that the workpieces in these areas have not been cut through. Based on the area warning in FIG. 6, the staff can directly and accurately determine which area has not been cut through, which is convenient for subsequent additional cutting processing.

The controller 50 directly determines the workpiece 10, and executes an additional cutting program.

First control the workpiece 10 to increase upwards by 2 mm at a speed of 10 mm/min, and the wire net 20 rotates in the first rotation direction, that is, to lay out new wires in the forward direction, and the wire feed speed is 0.03 m/s.

After the workpiece 10 is raised upwards by 2 mm, both the workpiece 10 and the wire net 20 stop running.

Start checking the length of the effective cutting line in the remaining wire amount in the old spool.

The remaining wire in the old spool is 10000 m, and there is a butt line, and the length of the butt line is 500 m.

When the length of the butt line is greater than zero, the length of the effective cutting line is the length of the remaining wire amount minus the length of the butt line. Therefore, the length of the effective cutting line is 9500 m, which is greater than the minimum cutting wire amount of 7000 m.

Then, the wire net 20 first rotates according to the second rotation direction for additional cutting and then rotates according to the first rotation direction to continue cutting, and alternately cuts according to the top speed until the cutting is completed.

Specifically, the wire net 20 first rotates according to the second rotation direction. That is, the old wire is laid out 2000 m first. The feed speed of the workpiece 10 is 0.2 mm/min, the linear speed of the wire net 20 rotating in the second direction is 30 m/s, and the flow rate of the cutting fluid is 240 l/min. Until the length of rotation according to the second rotation direction is cut.

Then, rotate according to the first rotation direction. That is to say, a new wire of 1500 m may be accepted. Correspondingly, the feed speed of the workpiece 10 is 0.2 mm/min. When the wire net 20 rotates in the first direction, the linear speed is 30 m/s, and the flow rate of the cutting fluid is 240 l/min. Until the length of rotation according to the second rotation direction is cut.

After two rounds of continuous cutting alternately in this way, the cutting ends.

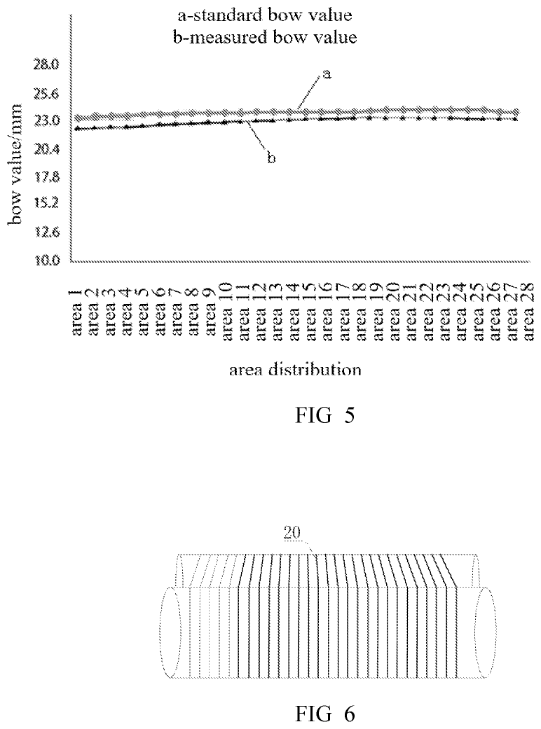

At the end, the detection part 40 continues to re-detect the bow value in each area. The graph of the obtained area-wire bow diagram is shown in FIG. 5. It can be seen that the measured bow values c obtained are all smaller than the standard bow value a, and it can be seen that the workpiece 10 has been completely cut through.

Compared with the existing manual processing method, this cutting method can shorten the cutting time by 0.67 min and reduce the labor cost by 50% compared with the cutting time and cutting quality.

A processing system of cutting through a workpiece includes:
a measurement module configured to obtain measured bow values of all areas in a wire net 20 when a total feed rate of a cutting of a workpiece 10 reaches a preset threshold;
a determiner configured to compare the measured bow values of all areas in the obtained wire net 20 with a standard bow value when the workpiece 10 is cut through;
the determiner determines that the workpiece 10 has been cut through when the measured bow values of all areas in the wire net 20 are less than or equal to the standard bow value; and
the determiner determines that the workpiece 10 is not cut through when any area of the wire net 20 has a measured bow value greater than the standard bow value.

The processing method of cutting the workpiece designed by the present disclosure measure the bow state of the wire net through the detection part, and automatically calculate the wire value, and automatically determine whether the ingot is cut through. This can also automatically adjust the slicing and cutting plan, avoid downtime and waste of man-hours, and improve slicing yield and work efficiency.

The present disclosure also proposes a processing system of cutting through the workpiece.

The embodiments of the present disclosure have been described in detail above. The content described is only a preferred embodiment of the present disclosure and cannot be considered as limiting the implementation scope of the present disclosure. All equal changes and improvements made according to the claims of the present disclosure should still belong to the scope covered by the patent of the present disclosure.

What is claimed is:

1. A processing method of cutting through a workpiece, comprising following steps:
obtaining measured bow values of all areas in a wire net when a feed rate of a workpiece cutting reaches a preset threshold;
comparing the measured bow values of all areas in an obtained wire net with a standard bow value when the workpiece is cut through;
determining that the workpiece has been cut through when the measured bow values of all areas in the wire net are less than or equal to the standard bow value; and
determining that the workpiece is not cut through when any area of the wire net has a measured bow value greater than the standard bow value.

2. The processing method of cutting through the workpiece according to claim 1, wherein the step of obtaining the measured bow values of all areas in the wire net comprises:
controlling detection parts placed in a slicing chamber to continuously detect a position height of all areas in the wire net sequentially along a length direction of the workpiece, and obtaining a position value of a lowest point of all areas in the wire net; and
obtaining the bow values of all areas in the wire net based on a height difference between a position of the lowest point of each area in a detected wire net and a position of a tangent point between the wire net and a sheave.

3. The processing method of cutting through the workpiece according to claim 2, wherein the detection parts are placed on two sides of a width of the wire net, and an emission port of the wire net is disposed in a same direction as a rotation direction of the wire net;
the detection parts placed on two sides of the width of the wire net alternately detect the wire net when the wire net rotates in a first rotation direction and rotates in a second rotation direction; and
the first rotation direction is the rotation direction of the wire net when the wire net is fed in; the second rotation direction is the rotation direction of the wire net when the wire net is taken up.

4. The processing method of cutting through the workpiece according to claim 1, wherein when the workpiece is not cut through, performing an additional cutting program, comprising:
controlling the workpiece to raise a certain distance, and then additionally cutting the workpiece;
when a total feed rate of an additional cutting reaches the preset threshold, obtaining the measured bow values of all areas in an additional cutting wire net;
comparing the measured bow values of all areas in an obtained additional cutting wire net with the standard bow value again to obtain a comparison result;
determining a cut-through of additionally cutting the workpiece based on the comparison result; and
repeating the above steps until the workpiece is cut through.

5. The processing method of cutting through the workpiece according to claim 4, wherein when the workpiece is raised upwards, the wire net rotates slowly at a certain speed until the workpiece is raised to a set distance and stops rotating.

6. The processing method of cutting through the workpiece according to claim 5, wherein the wire net rotates in the first rotation direction at a speed less than or equal to 0.1 m/s during an upward raising of the workpiece.

7. The processing method of cutting through the workpiece according to claim 5, wherein the workpiece is raised upwards by 2 mm to 5 mm at a preset feed speed, and a distance of the workpiece raised upwards is a non-interrupted operation.

8. The processing method of cutting through the workpiece according to claim 1, wherein when additionally cutting the workpiece, the method further comprises:
determining a length of an effective cutting line in a remaining wire amount in a spool; and
based on the length of the effective cutting line, determining the rotation direction of the wire net when additionally cutting the workpiece.

9. The processing method of cutting through the workpiece according to claim 8, wherein determining the length of the effective cutting line in the remaining wire amount in the spool comprises:
determining whether there is a butt line in the remaining wire amount in the spool; and
based on a length of the butt line, determining the length of the effective cutting line.

10. The processing method of cutting through the workpiece according to claim 9, wherein based on the length of the butt line, determining the length of the effective cutting line comprises:
when the length of the butt line is zero, the length of the effective cutting line is a length of the remaining wire amount;
when the length of the butt line is greater than zero, the length of the effective cutting line is the length of the remaining wire amount minus the length of the butt line.

11. The processing method of cutting through the workpiece according to claim 9, wherein based on the length of the butt line, determining the length of the effective cutting line comprises:
determining whether the length of the effective cutting line is greater than a length of a preset minimum cutting line amount;
when the length of the effective cutting line is greater than the length of a minimum cutting line amount, then
the wire net is first rotated to a certain length in the second rotation direction to cut, and then rotated to a certain length in the first rotation direction to continue cutting;
rotating in the second rotation direction and then rotating in the first rotation direction to cut alternately until an ending of cutting;
wherein a length of the wire net rotating in the second rotation direction is greater than a length of the wire net rotating in the first rotation direction;
when the length of the effective cutting line is greater than the length of the minimum cutting line amount, then
the wire net is first rotated to a certain length in the first rotation direction to cut, and then rotated to a certain length in the second rotation direction to continue cutting;
rotating in the second rotation direction and then rotating in the first rotation direction to cut alternately until the ending of cutting;
wherein the length of the wire net rotating in the first rotation direction is greater than the length of the wire net rotating in the second rotation direction;
wherein the minimum cutting line amount is not less than 7000 m.

12. The processing method of cutting through the workpiece according to claim 11, wherein the length of the wire net rotating in the first rotation direction and the length of the wire net rotating in the second rotation direction remain unchanged.

13. The processing method of cutting through the workpiece according to claim 1, wherein when additionally cutting the workpiece, a wire net speed, the feed speed, and a coolant flow rate are same when the wire net rotates in the first rotation direction and in the second rotation direction.

14. A processing system of cutting through a workpiece, comprising:
a measurement module configured to obtain measured bow values of all areas in a wire net when a total feed rate of a workpiece cutting reaches a preset threshold;
a determiner configured to compare the measured bow values of all areas in an obtained wire net with a standard bow value when the workpiece is cut through;
the determiner determines that the workpiece has been cut through when the measured bow values of all areas in the wire net are less than or equal to the standard bow value; and
the determiner determines that the workpiece is not cut through when any area of the wire net has a measured bow value greater than the standard bow value.

15. The processing system of cutting through the workpiece according to claim 14, wherein the measurement module is further configured to:
control detection parts placed in a slicing chamber to continuously detect a position height of all areas in the wire net sequentially along a length direction of the workpiece, and obtain a position value of a lowest point of all areas in the wire net; and
obtain the bow values of all areas in the wire net based on a height difference between a position of the lowest point of each area in a detected wire net and a position of a tangent point between the wire net and a sheave.

16. The processing system of cutting through the workpiece according to claim 15, wherein the detection parts are placed on two sides of a width of the wire net, and an emission port of the wire net is disposed in a same direction as a rotation direction of the wire net;
the detection parts placed on two sides of the width of the wire net alternately detect the wire net when the wire net rotates in a first rotation direction and rotates in a second rotation direction; and
the first rotation direction is the rotation direction of the wire net when the wire net is fed in; the second rotation direction is the rotation direction of the wire net when the wire net is taken up.

17. The processing system of cutting through the workpiece according to claim 14, wherein:
the determiner is configured to determine a length of an effective cutting line in a remaining wire amount in a spool; and
based on the length of the effective cutting line, the determine is configured to determine the rotation direction of the wire net when additionally cutting the workpiece.

18. The processing system of cutting through the workpiece according to claim 17, wherein:
the determiner is configured to determine whether there is a butt line in the remaining wire amount in the spool; and
based on a length of the butt line, the determiner is configured to determine the length of the effective cutting line.

19. The processing system of cutting through the workpiece according to claim 18, wherein:
when the length of the butt line is zero, the length of the effective cutting line is a length of the remaining wire amount;
when the length of the butt line is greater than zero, the length of the effective cutting line is the length of the remaining wire amount minus the length of the butt line.

20. The processing system of cutting through the workpiece according to claim 18, wherein a length of the wire net rotating in the first rotation direction and a length of the wire net rotating in the second rotation direction remain unchanged.
